(19) United States
(12) Patent Application Publication
(10) Pub. No.: US 2007/0295866 A1
(43) Pub. Date: Dec. 27, 2007

(54) Wall mounting bracket with a slide rail assembly

(76) Inventor: Chih-hong Yang, Taipei City (TW)

Correspondence Address: CHARLES E. BAXLEY, ESQ., 90 JOHN STREET, THIRD FLOOR, NEW YORK, NY, 10038, US

(21) Appl. No.: 11/475,739

(22) Filed: Jun. 26, 2006

(51) Int. Cl. F16L 3/08

(52) U.S. Cl. 248/70

(57) ABSTRACT

A wall mounting bracket with a slide rail assembly for positioning an article on a wall comprises a first rail, a second rail and a slide block. The second rail is slideably installed in a slide groove in two opposite sides of the first rail, the first and second rails define a guide groove for allowing the slide block to move therein, and the slide block can selectively move in the first or second rail, if desired. Hence, when an article is positioned on the slide block, the article can be adjusted to and positioned freely at any desired position by the slide block, and thus the applicability of the present invention is improved.

### BACKGROUND OF THE INVENTION

1. Field of the Invention

The present invention relates to a mounting device that can be moved and positioned freely, and more particularly to a wall mounting bracket with a slide rail assembly that allows an article to be mounted on a wall and to be moved and positioned freely.

2. Description of the Prior Art

In a home or at an exhibition, there are always some articles on a wall that need to adjust their positions, for example, the bath fittings (shower head, and other articles of the like to be mounted on the wall of the bathroom), the large-scale exhibition articles and the spot lights to be mounted on the wall of the exhibition hall. So far, there is no effective method for allowing the user to easily adjust the position of the articles hanging on the wall, usually, the user has to fix many rails, hooks or the like to the wall for hanging purposes.

In this present invention, the shower head is illustrated for exemplary only but not for limiting purposes, as shown in FIG. 1, a commonly seen wall mounting seat 10 is illustrated and provided for positioning a shower head 11. Although this design allows the user to grip the shower head 11 or hang it to the wall, it still has the following problems:

The shower head 11 is normally fixed during use (currently only the height-adjustable shower head is available on the market) since the mounting seat 10 is fixed, and it cannot be adjusted horizontally. And the user who is too short or tall has to hold shower head 11 with hand during shower, otherwise, the water cannot be sprayed on the user's body.

To solve the abovementioned problems, a height-adjustable rail was developed, however, this height-adjustable rail only allows the shower head to be adjusted in a single axial direction, the applicability of the present invention is still limited.

Regarding the large-scale exhibition articles and the spot lights to be mounted on the exhibition hall, they are either fixed or only unidireactionally adjustable. Based on many years of experiences in the related art field, the applicant of the application developed a wall mounting bracket with a slide rail assembly that not only can position an article on a wall but also can allow the user to adjust the article to any desired position freely.

### SUMMARY OF THE INVENTION

The primary objective of the present invention is to provide a wall mounting bracket with a slide rail assembly that not only can position an article on a wall but also allows the user to adjust the article to any desired position freely.

The wall mounting bracket with a slide rail assembly comprises a first rail, a second rail and a slide block. The second rail is slideably installed in a slide groove in two opposite sides of the first rail, the first and second rails define a guide groove for allowing the slide block to move therein. Hence, when an article is positioned on the slide block, the article can be adjusted to and positioned freely at any desired position by the slide block, and thus the applicability of the present invention is improved.

The secondary objective of the present invention is to provide a wall mounting bracket with a slide rail assembly that can allow the user to adjust the article to any desired position freely without the need of tools.

The first and second rails of the wall mounting bracket define a guide groove for allowing the slide block to move therein, and a plurality of elastic positioning assemblies and positioning cavities are arranged in the slide block and in the bottom of the guide grooves, such arrangements allow the user to move and position and the slide block freely. Therefore, the article to be mounted can be adjusted and positioned quickly and easily.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an illustrative view of showing that a conventional device for mounting a shower head on a wall;

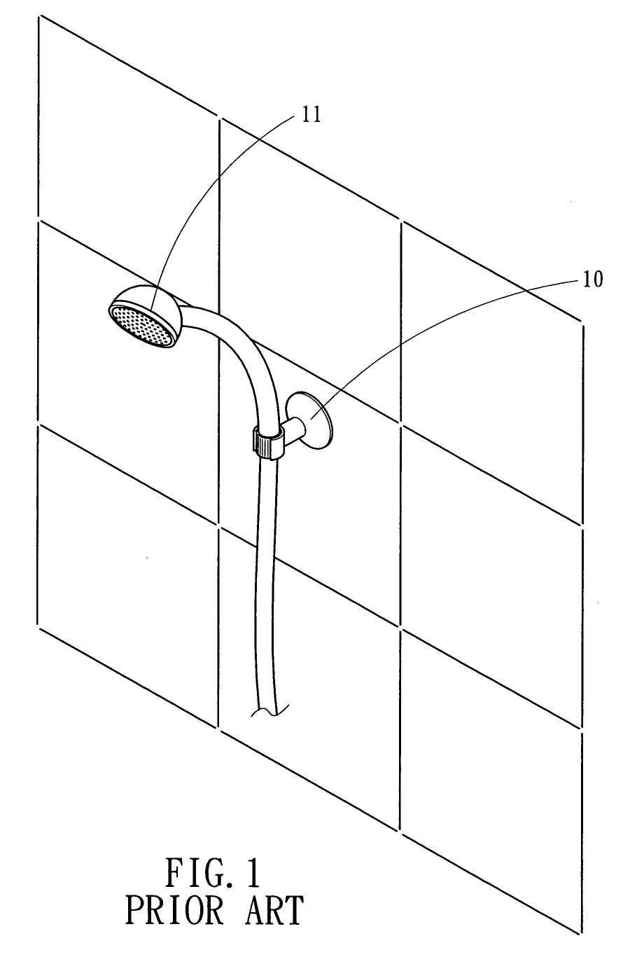

FIG. 2 is an exploded view of a wall mounting bracket with a slide rail assembly in accordance with the present invention;

FIG. 3 is an assembly perspective view of the wall mounting bracket with a slide rail assembly in accordance with the present invention;

FIG. 4 is a perspective view of the wall mounting bracket with a slide rail assembly in accordance with the present invention, in which, the shower head is positioned on a different position;

FIG. 5 is an assembly cross sectional view of the wall mounting bracket with a slide rail assembly in accordance with the present invention; and

FIG. 6 is an enlarged cross sectional view of showing a part of the wall mounting bracket with a slide rail assembly in accordance with the present invention.

### DETAILED DESCRIPTION OF THE PREFERRED EMBODIMENT

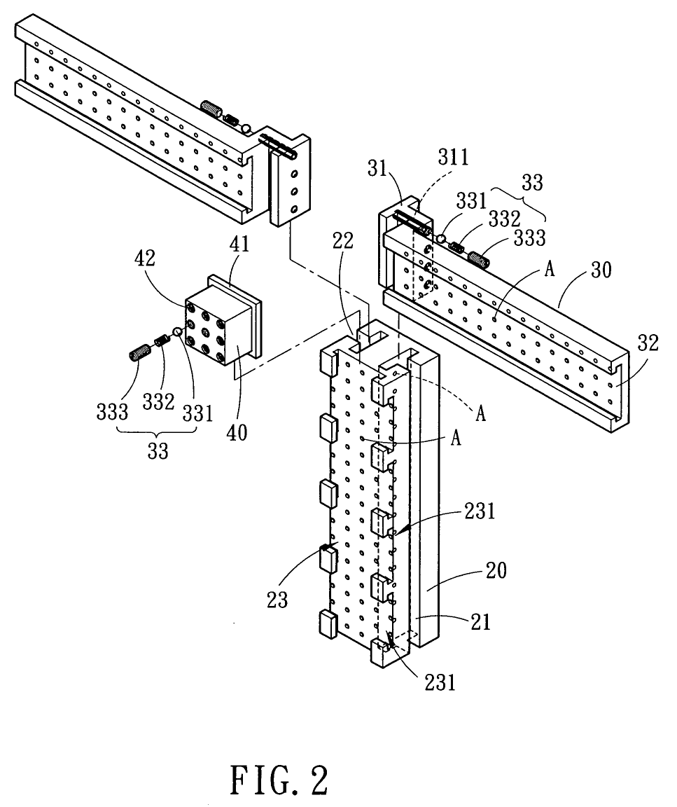

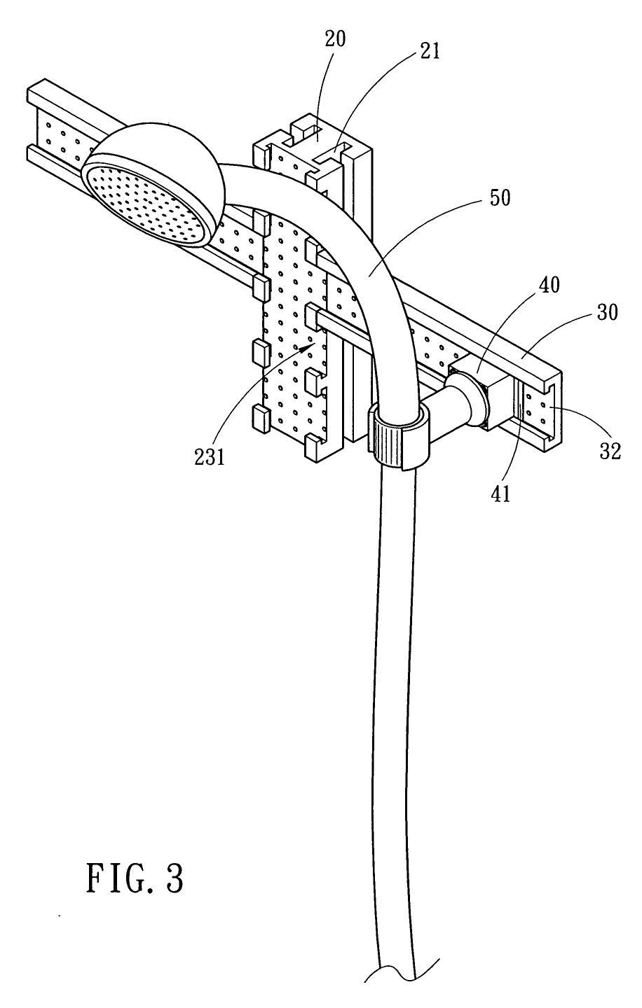

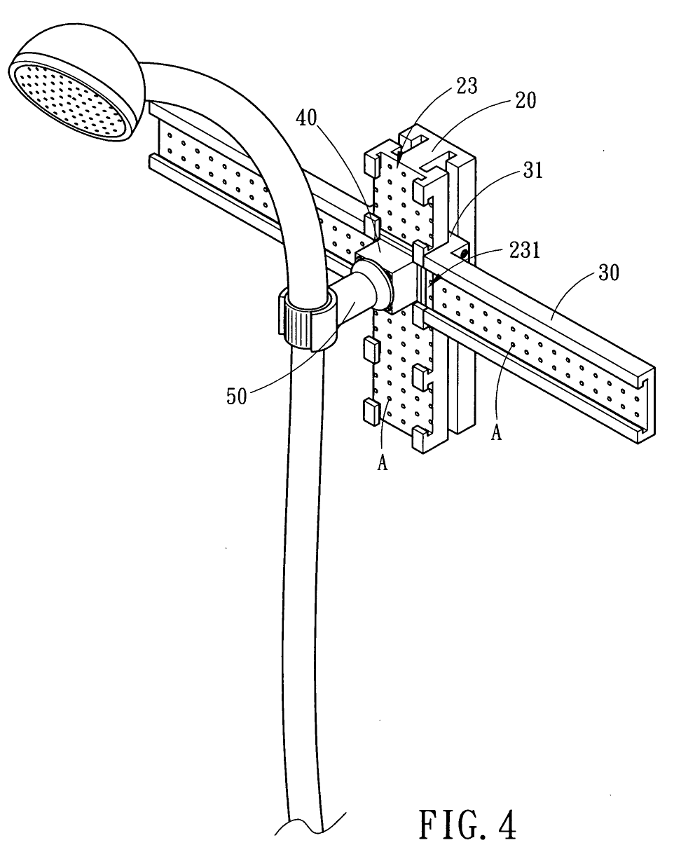

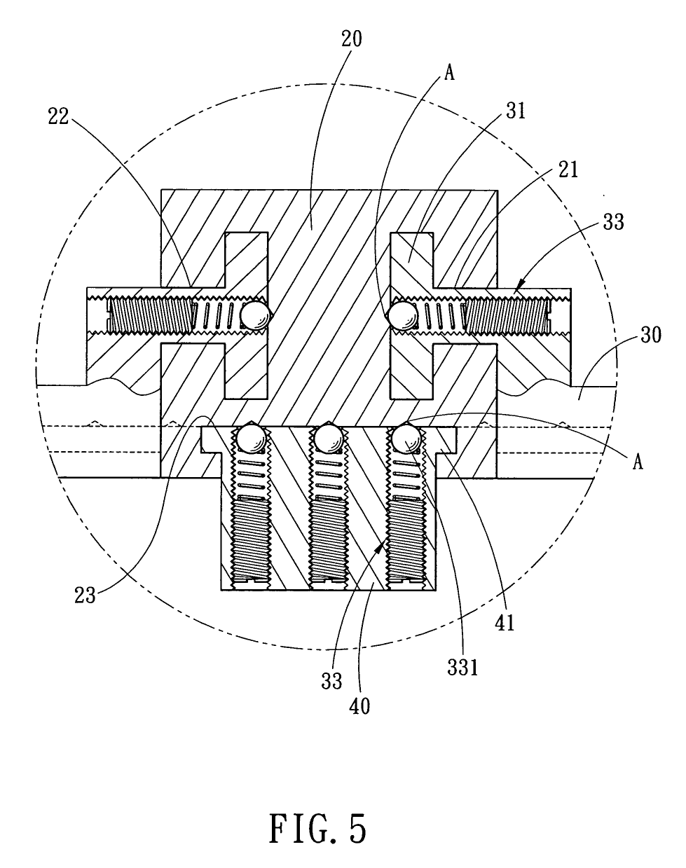

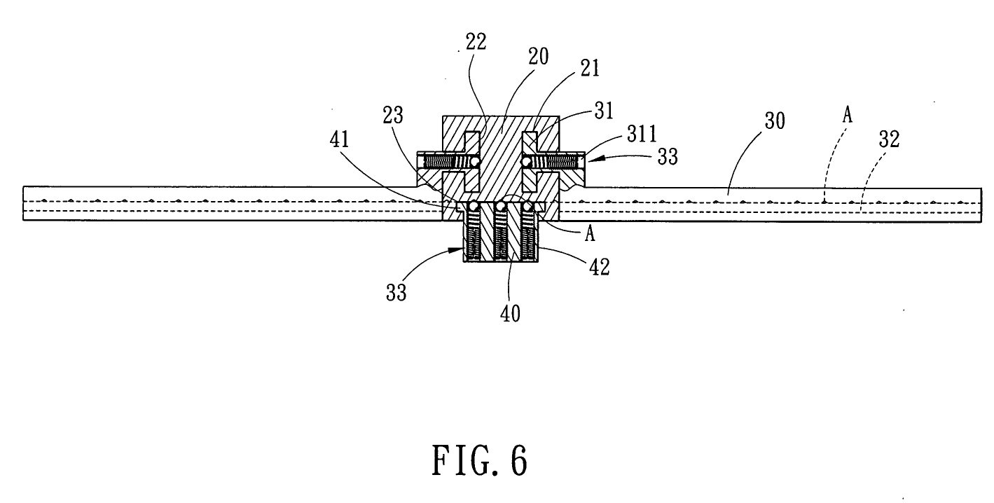

The foregoing, and additional objects, features and advantages of the present invention will become apparent from the following detailed description of preferred embodiment thereof, taken in conjunction with the accompanying FIGS. 2-6.

A wall mounting bracket with a slide rail assembly in accordance with the present invention comprises: a first rail 20, two second rails 30, a slide block 40 and an article 50 to be mounted (which is a shower head for example).

The first rail 20 is fixed on a wall, two slide grooves 21 and 22 are formed in two opposite sides of the first rail 20, a T-shaped guide groove 23 is defined in a side of the first rail 20 between the two slide grooves 21 and 22 and is arranged 90 degrees relative to the two slide grooves 21 and 22. A plurality of T-shaped notches 231 are defined at either side of the T-shaped guide groove 23, and a plurality of positioning cavities A are defined in the bottom of the slide grooves 21, 22 and the guide groove 23 and are located correspondingly to the notches 231.

Each of the second rails 30 has a T-shaped end 31 to be slideably and vertically engaged in the slide grooves 21 and 22 of the first rail 20. A T-shaped guide groove 32 is formed in each of the second rails 30, and in the bottom surface of the T-shaped guide groove 32 are also formed a plurality of positioning cavities A. A plurality of through threaded holes 311 are defined in the T-shaped end 31 of the second rails 30 and located correspondingly to the positioning cavities A of the first rail 20 for accommodation of a plurality of elastic positioning assemblies 33 each of which includes a steel ball 331, a spring 332 and an adjustment screw 333. The steel ball 331 is engaged in any of the positioning cavities A of the slide grooves 21 and 22 of the first rail 20. Since the positioning cavities A are located correspondingly to the notches 231, when the second rails 30 are positioned, their T-shaped guide grooves 32 will be jointed to the corresponding notches 23 of the first rail 20.

The slide block 40 has a positioning flange 41 formed at the peripheral edge of the bottom thereof, and the positioning flange 41 is slideably confined in the T-shaped guide grooves 32 and 23 of the second rails 30 and the first rail 20, so that the slide block 40 will not fall off. The slide block 40 and the positioning flange 41 thereof are shaped to fit the contour of the notches 23 of the first rail 20, namely, cooperates with the slide block to form a T-shape configuration to fit the notches 23 of the first rail 20. A plurality of through threaded holes 42 are formed in the slide block 40 for accommodation of an elastic positioning assembly 33 which includes a steel ball 331, a spring 332 and an adjustment screw 333. The steel ball 331 is engaged in any of the positioning cavities A of the guide groove 23 of the first rail 20.

The article 50 is positioned on the slide block 40.

When the first or second rails move linearly:

the slide block 40 carrying the article 50 will move together with the first or second rails 20, 30, and meanwhile the elastic positioning assembly 33 is locked in the desired one of the positioning cavities A of the guide grooves 23 and 32, therefore, the slide block 40 can move stably and can be positioned easily.

When the present invention is switched to move horizontally or vertically:

Since the T-shaped end 31 of the second rails 30 is slideably engaged in the slide grooves 21 and 22 of the first rail 20 when the slide block 40 moves on the first rail 20, plus the T-shaped guide grooves 32 can be jointed to the corresponding notches 23 of the first rail 20 once the second rails 30 are positioned, the slide block 40 carrying the article 50 can pass through the notches 231 at both sides of the guide groove 23 (the positioning flange 41 of the slide block 40 passes through the T-shaped notch 231) and then moves into the guide groove 32 of the second rail 30 or the guide groove 23 of the first rail 20.

Since the first and second rails 20, 30 can be moved and adjusted relative to each other, the elastic positioning assembly 33 can cooperate with the positioning cavities A to enable the sliding block 40 to be firmly positioned in the guide grooves 23 and 32. Therefore, the respective components can be adjusted and positioned easily as desired.

The engagement and disengagement between the elastic positioning assembly 33 and the positioning cavities A must be achieved by applying a certain force (which is determined by the elastic force of the spring 332 and the number of the elastic positioning assembly 33). The slide block 40 shown in the drawings is provided with nine elastic positioning assemblies 33, and the force applied is also determined by the weight of the article mounted on the slide block 40. In operation, the user simply needs to apply a force in the axial direction of the guide grooves 23 or 32, the steel ball 331 will withdraw and move to the desired group of positioning cavities A with the cooperation of the spring 332. Hence, the shower head can be adjusted and positioned easily and quickly by the device of the present invention.

On the other hand, the guide grooves 23, 32 and the positioning flange 41 of the slide block 40 also can be T-shaped or dovetail-shaped, or can be in any other shapes.

It will be noted that there is no notches in both sides of the guide groove 32 of the second rails 30, and this design is suitable for a vertical wall, for preventing the slide block 40 from falling off toward the ground as it enters the second rails 30. And the guide groove 32 of the second rails 30 also can have notches according to needs (for example, when used on a horizontal wall).

In addition, the first and second rails 20, 30 can be lengthened as desired by connecting a plurality of first or second rails 20, 30 with one another.

While we have shown and described various embodiments in accordance with the present invention, it should be clear to those skilled in the art that further embodiments may be made without departing from the scope of the present invention.

What is claimed is:

1. A wall mounting bracket with a slide rail assembly comprising at least one first rail, one second rail and one slide block for carrying an article to be mounted; wherein
the first rail has at least one slide groove and one guide groove that are vertical to each other, and a plurality of notches are formed in periphery of the guide groove;
the second rail has one end slideably engaged in the guide groove of the first rail, the second rail is vertically jointed to the first rail, a guide groove is formed in the second rail and located correspondingly to the notches of the first rail; and
the slide block has one end slideably received in the guide groove of the first rail or the second rail and is located correspondingly to the notches of the first rail, and the slide block can pass through the notches, when desired.

2. The wall mounting bracket with a slide rail assembly as claimed in claim 1, wherein a plurality of positioning cavities are formed in the bottom of the first rail, and a plurality of through threaded holes are defined in the slide block for accommodation of a plurality elastic positioning assemblies each of which includes a steel ball, a spring and an adjustment screw, the steel ball is engaged in any of the positioning cavities in the bottom of the guide groove of the first rail.

3. The wall mounting bracket with a slide rail assembly as claimed in claim 1, wherein a plurality of positioning cavities are formed in the bottom of the second rail, and a plurality of through threaded holes are defined in the slide block for accommodation of a plurality elastic positioning assemblies each of which includes a steel ball, a spring and an adjustment screw, the steel ball is engaged in any of the positioning cavities in the bottom of the guide groove of the second rail.

4. The wall mounting bracket with a slide rail assembly as claimed in claim 1, wherein a plurality of positioning cavities are formed in the bottom of the first and second rails, and a plurality of through threaded holes are defined in the slide block for accommodation of a plurality elastic positioning assemblies each of which includes a steel ball, a spring and an adjustment screw, the steel ball is engaged in any of the positioning cavities in the bottom of the guide groove of the first and second rails.

5. The wall mounting bracket with a slide rail assembly as claimed in claim 1, wherein a plurality of positioning cavities are formed in the bottom of the first rail, and a plurality of through threaded holes are defined in the one end of the second rail for accommodation of a plurality elastic positioning assemblies each of which includes a steel ball, a spring and an adjustment screw, the steel ball is engaged in any of the positioning cavities in the bottom of the guide groove of the first or second rails.

6. The wall mounting bracket with a slide rail assembly as claimed in claim 2, wherein a plurality of positioning cavities are formed in the bottom of the first rail, and a plurality of through threaded holes are defined in one end of the second rail for accommodation of a plurality elastic positioning assemblies each of which includes a steel ball, a spring and an adjustment screw, the steel ball is engaged in any of the positioning cavities in the bottom of the guide groove of the first or second rails.

7. The wall mounting bracket with a slide rail assembly as claimed in claim 1, wherein the notches, the slide groove, and the guide groove of the first rail are T-shaped, the one end and the guide groove of the second rail are T-shaped, the slide block has a flange which cooperates with the slide block to form a T-shape configuration, so as to prevent the slide block from falling off.

8. The wall mounting bracket with a slide rail assembly as claimed in claim 2, wherein the notches, the slide groove, and the guide groove of the first rail are T-shaped, the one end and the guide groove of the second rail are T-shaped, the slide block has a flange which cooperates with the slide block to form a T-shape configuration, so as to prevent the slide block from falling off.

9. The wall mounting bracket with a slide rail assembly as claimed in claim 3, wherein the notches, the slide groove, and the guide groove of the first rail are T-shaped, the one end and the guide groove of the second rail are T-shaped, the slide block has a flange which cooperates with, the slide block to form a T-shape configuration, so as to prevent the slide block from falling off.

10. The wall mounting bracket with a slide rail assembly as claimed in claim 4, wherein the notches, the slide groove, and the guide groove of the first rail are T-shaped, the one end and the guide groove of the second rail are T-shaped, the slide block has a flange which cooperates with the slide block to form a T-shape configuration, so as to prevent the slide block from falling off.

11. The wall mounting bracket with a slide rail assembly as claimed in claim 5, wherein the notches, the slide groove, and the guide groove of the first rail are T-shaped, the one end and the guide groove of the second rail are T-shaped, the slide block has a flange which cooperates with the slide block to form a T-shape configuration, so as to prevent the slide block from falling off.

12. The wall mounting bracket with a slide rail assembly as claimed in claim 1, wherein the notches, the slide groove, and the guide groove of the first rail are dovetailed, the one end and the guide groove of the second rail are dovetailed, the slide block has a flange which cooperates with the slide block to form a dovetailed configuration, so as to prevent the slide block from falling off.

13. The wall mounting bracket with a slide rail assembly as claimed in claim 2, wherein the notches, the slide groove, and the guide groove of the first rail are dovetailed, the one end and the guide groove of the second rail are dovetailed, the slide block has a flange which cooperates with the slide block to form a dovetailed configuration, so as to prevent the slide block from falling off.

14. The wall mounting bracket with a slide rail assembly as claimed in claim 3, wherein the notches, the slide groove, and the guide groove of the first rail are dovetailed, the one end and the guide groove of the second rail are dovetailed, the slide block has a flange which cooperates with the slide block to form a dovetailed configuration, so as to prevent the slide block from falling off.

15. The wall mounting bracket with a slide rail assembly as claimed in claim 4, wherein the notches, the slide groove, and the guide groove of the first rail are dovetailed, the one end and the guide groove of the second rail are dovetailed, the slide block has a flange which cooperates with the slide block to form a dovetailed configuration, so as to prevent the slide block from falling off.

16. The wall mounting bracket with a slide rail assembly as claimed in claim 5, wherein the notches, the slide groove, and the guide groove of the first rail are dovetailed, the one end and the guide groove of the second rail are dovetailed, the slide block has a flange which cooperates with the slide block to form a dovetailed configuration, so as to prevent the slide block from falling off.
